(19) United States
(12) Patent Application Publication
(10) Pub. No.: US 2009/0216894 A1
(43) Pub. Date: Aug. 27, 2009

(54) RELAY APPARATUS FOR USE IN E-MAIL-BASED CHAT SYSTEM

(75) Inventors: Takahiro SAGARA, Ebina (JP); Masahiko Nakahara, Machida (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/390,028

(22) Filed: Feb. 20, 2009

(30) Foreign Application Priority Data
Feb. 22, 2008 (JP) 2008-040821

(51) Int. Cl. G06F 15/16

(52) U.S. Cl. 709/230

(57) ABSTRACT

The present invention provides an e-mail-based chat system that is available from a terminal without a push architecture and can be used with an existing server. The invention relates to a relay apparatus to be installed on communication lines between terminals and servers consisting of a transmission server and a retrieval server. The relay apparatus puts on hold data retrieval requests received from the terminals without relaying the data retrieval requests to the retrieval server and withholds responses to the terminals. When the relay apparatus receives chat message data from a terminal, it relays the data to the transmission server. Right after the relaying of the data, the relay apparatus acquires the data from the transmission server via the retrieval server and creates response data from the acquired data, thus responding to the data retrieval requests on hold with the response data.

### INCORPORATION BY REFERENCE

This application claims priority based on a Japanese patent application, No. 2008-040821 filed on Feb. 22, 2008, the entire contents of which are incorporated herein by reference.

### BACKGROUND OF THE INVENTION

The present invention relates to a relay apparatus to be used on communication lines between terminals and a server(s) in a network system such as the World Wide Web (WWW) and the like that exchanges data among them.

Highly real-time chat programs have been popular on the Internet, which are used for multiple users to have text-based conversations. Today, the explosive growth of mobile phones has led to suggestions of chat systems available also from the mobile phones. For example, Japanese Unexamined Patent Application No. 2004-252614 discloses an e-mail-based chat system in which messages posted by multiple users with their mobile phones or the like are distributed collectively to the users with the use of e-mail the format of which is common among their mobile phone companies.

### SUMMARY OF THE INVENTION

When such an e-mail-based chat system is used not from a mobile phone terminal with a push architecture but from a terminal without the push architecture such as a PC or the like, the terminal without it needs to check a data retrieval server for incoming e-mails at particular intervals. Accordingly, the timing of e-mail retrieval (i.e., reading posted messages) may not be synchronous among the terminals of chat participants in a chat room. This often leads to the problem that messages posted by a chat participant may be incongruous with other messages posted by the other participants due to a time lag when the user is using a terminal without the push architecture.

For the terminal without the push architecture to acquire data using the occurrence of a particular event in a server as a trigger, a pseudo-push architecture has been disclosed in which the server withholds for a particular amount of time a response to a data retrieval request made by the terminal to the server when the data is not present in the server (refer to Japanese Unexamined Patent Application No. 2002-342201, for example). When this method is to be employed, the server is required to additionally have a mechanism for withholding the response. This means the existing server already installed needs to be modified, which is hard to achieve. Further, because the server has to maintain the connection to the terminal, the server load would increase.

The present invention provides an e-mail-based chat system which is available even from a terminal without the push architecture, can be used with an existing server, and is less prone to incongruity of posted messages.

The disclosed system has a relay apparatus installed on communication lines between terminals and a server(s). When the relay apparatus receives data retrieval requests (that is, requests to receive chat messages) directed to the server from the terminals, it puts responses to the requests on hold without relaying the requests to the server. The relay apparatus receives the requested chat messages from the server and responds to the requests of the terminals on hold after it relays a data transmission request (that is, a request to transmit a chat message) from any one of the terminals to the server. This enables simultaneous transmission of the requested chat data to the multiple data-retrieval requesting terminals.

The relay apparatus transmits the chat data simultaneously to multiple terminals also after the relay apparatus receives a particular number of data-transmission requests (chat messages) from the terminals or after the passage of a particular amount of time. Further, the relay apparatus can reduce the data traffic between the terminals and server by putting multiple chat messages together into a single response and transmitting the response to the terminals.

The relay apparatus of the disclosed system also interprets the command statement included in a request from a terminal and executes a predetermined operation according to the command statement, thereby transmitting the information of requests on hold to the terminal or performing an authorization operation on the terminal.

Multiple relay apparatuses as defined by the disclosed system can be installed on communication lines between the terminals and server. By exchanging information with one another, the multiple relay apparatuses can transmit data simultaneously to the terminals, which diffuses the data processing load among the relay apparatuses.

In one aspect, the invention is a relay apparatus connected via a network to a plurality of terminals and a server, the relay apparatus comprising:

a data retrieval request receiving unit for receiving from one or more of the terminals data retrieval requests directed to the server and putting transmission of the requests on hold;

a data transmission request relay unit for relaying a data transmission request from any of the terminals to the server;

a data retrieval request unit for making a request to the server for data retrieval based on the data retrieval requests on hold and receiving the requested data from the server after the data transmission request relay unit relays the data transmission request from any of the terminals to the server; and

a response data generation unit for generating response data for the data retrieval requests on hold based on the requested data received by the data retrieval request unit from the server and transmitting the response data to the one or more of the terminals.

Preferably, for each of the data retrieval requests on hold, the data retrieval request receiving unit manages as coupling information the address of a data-retrieval requesting terminal and the server information that identifies the address of and a position inside the server from which to retrieve the requested data.

Preferably, by referring to the coupling information, the data retrieval request receiving unit transmits a data retrieval request based on the data retrieval requests on hold to a particular position inside the server with the use of the server information of the entries in the coupling information that have the same terminal address as that of a data-transmission requesting terminal.

Preferably, by referring to the coupling information, the response data generation unit generates, from the data received from the particular position inside the server in response to the data retrieval request transmitted by the data retrieval request receiving unit, response data directed to the data-retrieval requesting terminals having the same server information as that of the data-transmission requesting terminal in the coupling information.

Preferably, the data retrieval request receiving unit manages, as the coupling information, protocols used by the terminals having data retrieval requests put on hold, and the response data generation unit generates the response data according to the protocols.

Other features of the disclosed system as well as the above will become apparent from the following description of embodiments with reference to the accompanying drawings.

In accordance with the teaching herein, a highly real-time, e-mail-based chat system can be provided that is available from a terminal without a push architecture, can be used with an existing server, and is less prone to incongruity of posted messages.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 illustrates the logical framework of a communication system in Embodiments 1 to 4;

FIG. 2 illustrates the functional configuration of a relay apparatus as used in Embodiments 1 to 3;

FIG. 3 illustrates the physical configuration of a computer that implements a relay apparatus as used in Embodiments 1 to 4;

FIG. 4 illustrates an example of the coupling information stored in the coupling information storage unit of Embodiment 1;

FIG. 5 illustrates an example of the communication sequence of Embodiment 1 among terminals, a relay apparatus, and servers;

FIG. 6 is a flowchart illustrating the process flow upon receipt of a data retrieval request in Embodiment 1;

FIG. 7 is a flowchart illustrating the process flow of making a data retrieval request to a retrieval server in Embodiment 1;

FIG. 8 is a flowchart illustrating the process flow of creating and transmitting response data to a data retrieval request in Embodiment 1;

FIG. 9 illustrates an example of the coupling information stored in the coupling information storage unit of Embodiment 2;

FIG. 10 illustrates an example of the communication sequence of Embodiment 2 among terminals, a relay apparatus, and servers;

FIG. 11 is a flowchart illustrating the process flow of judging whether or not to make a data retrieval request to a retrieval server in Embodiment 2;

FIG. 12 illustrates an example of the control information stored in the coupling information storage unit of Embodiment 3;

FIG. 13 illustrates an example of the communication sequence of Embodiment 3 between a terminal and a relay apparatus;

FIG. 14 is a flowchart illustrating the process flow of interpreting the command statement included in a request and executing a particular operation in Embodiment 3;

FIG. 15 is a flowchart illustrating the process flow of transmitting the information on request on hold in Embodiment 3;

FIG. 16 is a flowchart illustrating the process flow of authorizing a request in Embodiment 3;

FIG. 17 illustrates the configuration of one of the relay apparatuses used in Embodiment 4; and

FIG. 18 illustrates an example of the communication sequence of Embodiment 4 among terminals, relay apparatuses, and servers.

### DETAILED DESCRIPTION OF THE EMBODIMENTS

Embodiments are described below with reference to the accompanying drawings.

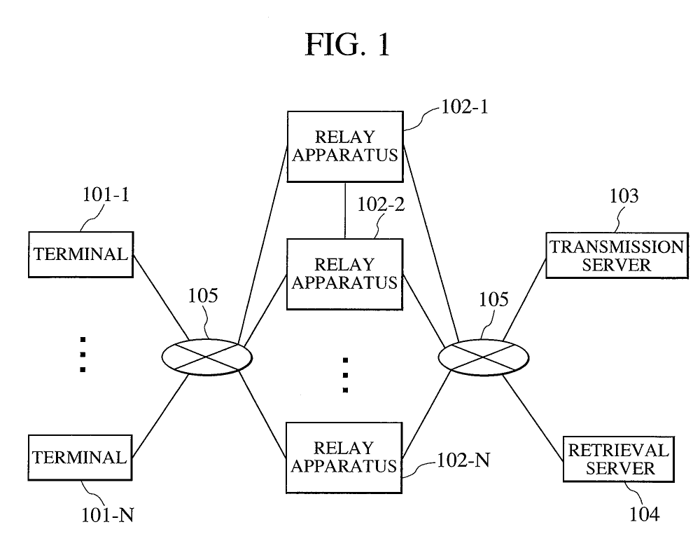

FIG. 1 illustrates one of the exemplary configurations of a communication system using such relay apparatuses as are used in Embodiments 1 to 4.

As shown in FIG. 1, the communication system includes one or more terminals 101; a transmission server 103 that transfers received data to a retrieval server 104; the retrieval server 104 that transfers data to data-requesting terminals (101); and relay apparatuses 102. These are connected via networks 105. When the data is in the form of e-mail, the transmission server 103 is an SMTP (simple mail transfer protocol) server and the like, the retrieval server 104 being an IMAP (Internet message access protocol) server and the like. Unlike FIG. 1, multiple transmission servers 103 and retrieval servers 104 can instead be provided. Alternatively, one server can be allowed to have the functions of the transmission server 103 and the retrieval server 104.

Embodiments 1 to 3 are to explain communication systems each with one relay apparatus 102.

### Embodiment 1

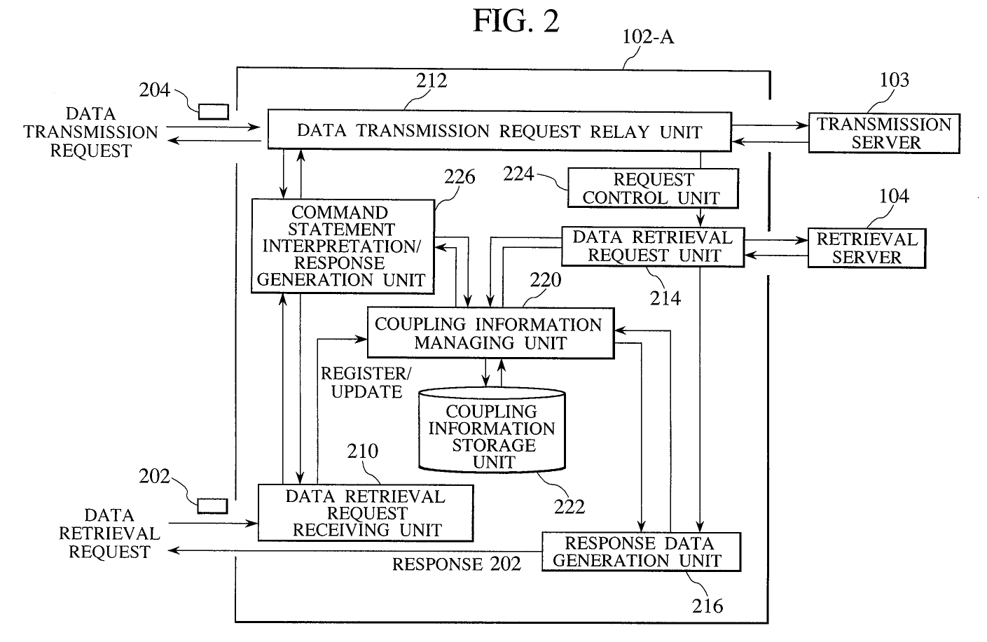

FIG. 2 illustrates the functional configuration of the relay apparatus 102 as used in Embodiments 1 to 3.

As shown in FIG. 2, the relay apparatus, designated 102-A in the figure, includes the following components: a data retrieval request receiving unit 210; a coupling information storage unit 222; a coupling information managing unit 220; a data transmission request relay unit 212; a data retrieval request unit 214; and a response data generation unit 216. The data retrieval request receiving unit 210 is capable of receiving data retrieval requests 202 from the terminals 101 and of putting them on hold. The coupling information storage unit 222 stores in a correlated manner the terminal information of a data-retrieval requesting user and the information of the retrieval server 104 from which to retrieve the data. The coupling information managing unit 220 manages thus stored information in the coupling information storage unit 222. The data transmission request relay unit 212 relays data transmission requests 204 from the terminals 101 to the transmission server 103. The data retrieval request unit 214 makes requests to the retrieval server 104 for transfer of data position inside the retrieval server 104 and data acquisition from the retrieval server 104. The response data generation unit 216 generates response data for the data retrieval requests 202 on hold.

Note that a request control unit 224 and a command statement interpretation/response generation unit 226 are not used in Embodiment 1 but in Embodiment 2 and Embodiment 3, respectively.

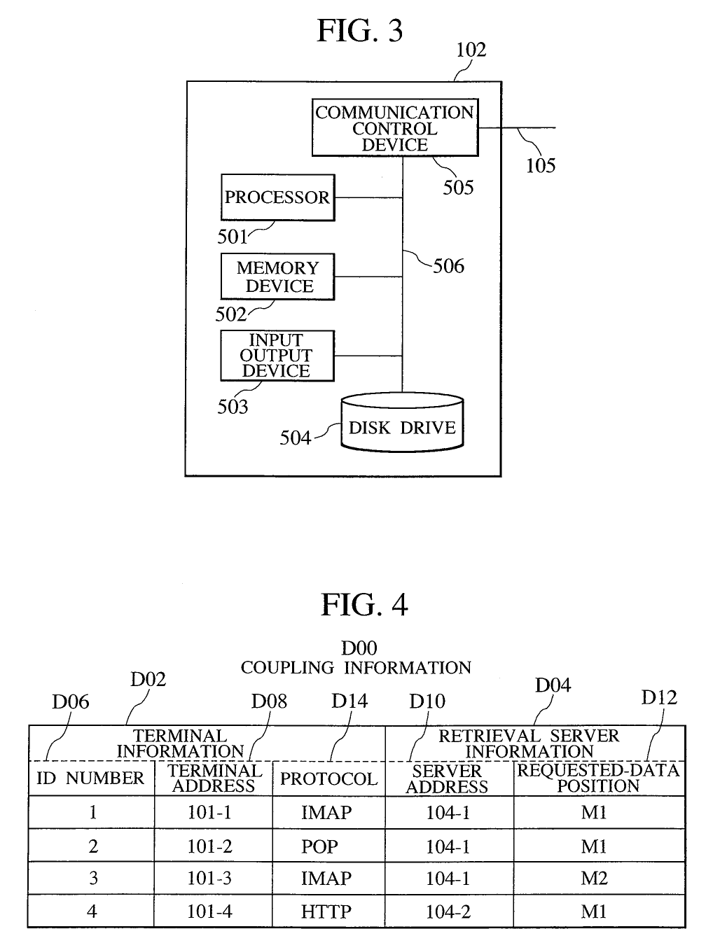

FIG. 3 illustrates the physical configuration of the relay apparatus 102 as used in Embodiments 1 to 4. The relay apparatus 102 is implemented by a computer including a processor 501; a memory device 502; an input device 503; a disk drive 504; a communication control device 505; and internal communication lines (internal buses) 506. The processor 501 executes programs for the rest of the components to perform respective operations. The memory device 502 reads some of the programs to be executed and associated data and temporarily stores them. The input device 503 is used to externally input instructions and information. The disk drive 504 is used to store the programs and the like, that is, used as a data storage unit. The communication control device 505 controls data communication between the internal components of the relay apparatus 102 and the network 105. The internal communication lines 506 serve to transfer data among the internal components of the relay apparatus 102.

The above-mentioned programs may be installed in advance on the disk drive 504 inside the computer, or the relay apparatus 102. Alternatively, the programs may be installed on the disk drive 504 on an as-needed basis from another device via the communication control unit 505 or a peripheral-device control device not shown and via a medium that can be used by the above computer. The word ‘medium’ as used herein refers, for example, to a storage medium detachable from the input/output interfaces of the computer or to a communication medium (a network or carrier waves and digital signals that are transmitted though the network).

FIG. 4 is an exemplary table stored on the coupling information storage unit 22 of Embodiment 1 in which the terminal information of a data retrieval requesting terminal and the information of the retrieval server 104 from which to retrieve the data are correlated or coupled (the table is hereinafter referred to as coupling information D00). A data entry is registered in the coupling information D00 by the coupling information managing unit 220 when the data retrieval request receiving unit 210 receives a data retrieval request from one of the terminals 101. The entry is deleted after the data retrieval request receiving unit 210 returns a response to the request.

The entry in the coupling information D00 has terminal information D02 and retrieval server information D04. The terminal information D02 includes a unique identification number D06; the terminal address D08 (an IP address or the like) on the network 105 the data-requesting terminal is using; and the protocol D14 through which the data-requesting terminal sent the data retrieval request. The retrieval server information D04 includes the address D10 (similar to the terminal address D08) of the retrieval server 104 from which to retrieve the data and a requested-data position D12 that indicates the position inside the retrieval server 104 from which to retrieve the data. The requested-data position is the name of an e-mail box, for example, ‘news/sports’ when the data is in the form of e-mail; the requested-data position corresponds to a chat room.

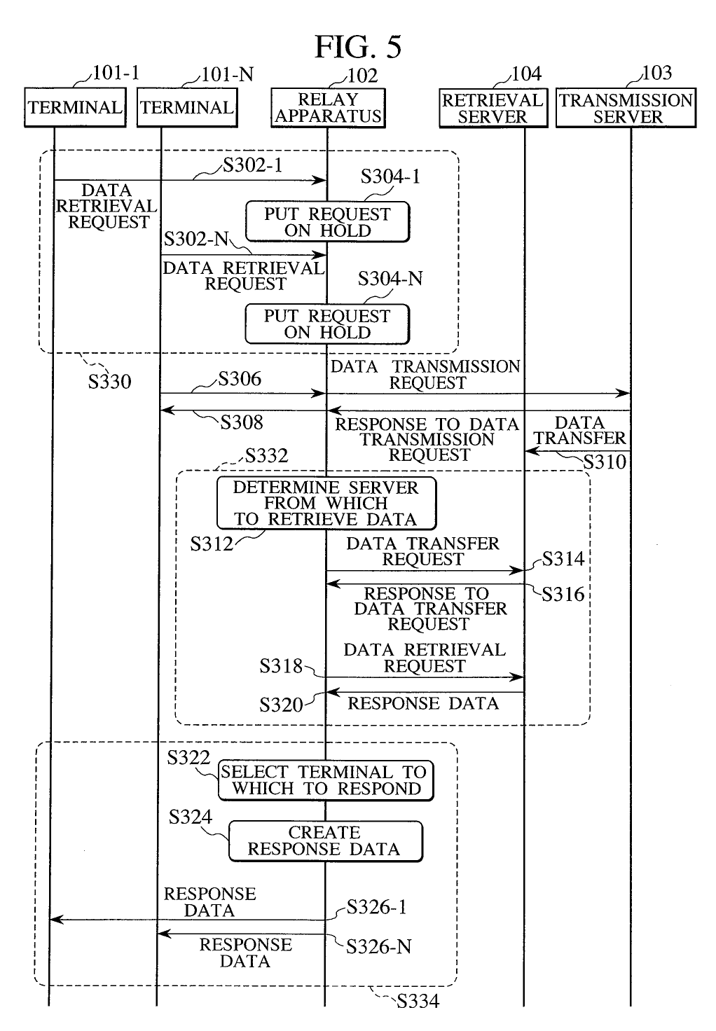

FIG. 5 illustrates an example of the communication sequence of Embodiment 1. The data retrieval request receiving unit 210 of the relay apparatus 102 first receives a data retrieval request (S302-1) to the retrieval server 104 that is transmitted repeatedly (or periodically) by a terminal 101-1. The data retrieval request receiving unit 210 then puts the request on hold (S304-1) without returning a request response to the terminal 101-1. Even when the data retrieval request from the terminal 101-1 (S302-1) is on hold, the data retrieval request receiving unit 210 further receives data retrieval requests (S302-N) from other terminals 101-N and puts them on hold (S304-N). Note that after the data retrieval request receiving unit 210 receives a data retrieval request, the coupling information managing unit 220 of the relay apparatus 102 registers an entry in the coupling information D00 stored on the coupling information storage unit 222.

When one of the terminals 101-N transmits as a chat message a data transmission request that is directed to the retrieval server 104 toward the transmission server 103 (S306), the data transmission request relay unit 212 of the relay apparatus 102 receives that request and relays it to the transmission server 103. The data transmission request relay unit 212 then relays a response to the request from the transmission server 103 to the data-transmission requesting terminal (S308). After receiving the data transmission request, that is, the chat message from the relay apparatus 102, the transmission server 103 transfers it to the retrieval server 104 (S301). A protocol to be used for the data transfer is an SMTP or the like when the data is in the form of e-mail.

Using as an event trigger the relaying of the data transmission request (S306) by the data transmission request relay unit 212 to the transmission server 103, the data retrieval request unit 214 of the relay apparatus 102 acquires from the retrieval server 104 data relevant to one or more of the data retrieval requests. Used as the address of the retrieval server 104 from which to retrieve the data is the address D10 of the entry in the coupling information D00 that has the same terminal address D08 as that of the data-transmission requesting terminal.

When all the chat message data received by the retrieval server 104 from the transmission server 103 is to be stored in a single directory or the like (the data is stored in the mail box ‘INBOX’ when the retrieval server is an IMAP server), particular chat message data sent by a chat participant needs to be transferred to a particular data position inside the retrieval server 104, which position corresponds to the chat room the participant is using. Used as the data transfer destination is the requested-data position D12 of the entries in the coupling information D00 that have the same terminal address D08 as that of the data-transmission requesting terminal.

After the data transmission request relay unit 212 relays the data transmission request to the transmission server 103, the data retrieval request unit 214 determines a retrieval server from which to retrieve the chat message data (S312); in this case, that retrieval server is the retrieval server 104. The data retrieval request unit 214 first issues a data transfer request (S314) to the retrieval server 104 for transferring the chat message data inside the retrieval server 104 to a request-data position D12 inside the retrieval server 104 and then receives a response from the retrieval server 104 (S316). After recognizing a successful data transfer by that response, the data retrieval request unit 214 issues a data retrieval request (S318) to the retrieval server 104 and receives a response (S320), i.e., the chat message data from the retrieval server 104. The data transfer request (S314) may be skipped, if the data exists at the requested data position because the retrieval server 104 has only one chat room.

The following are examples of the data transfer request (S314) and the data retrieval request (S318). When the retrieval server 104 is an IMAP server and when the data with the message number 1 is transferred to the mail box “news/sports,” the data transfer request (S314) reads “001 COPY 1 “news/sports” 002 STORE DELETED 1.” When the data with the message number 1 is retrieved from the “news/sports” mail box, the data retrieval request (S318) reads “003 SELECT “news/sports” 004 FETCH 1.”

The response data generation unit 216 selects, among the data retrieval requests on hold, requests having the same requested-data position D12 as that of the data-transmission requesting terminal in their entries, i.e., selects terminals using the same chat room (S322). The response data generation unit 216 then generates response data (S324) using the data (chat message data) received from the data retrieval request unit 214 and returns the response data to the selected data-retrieval requests on hold (S326-1, S326-N).

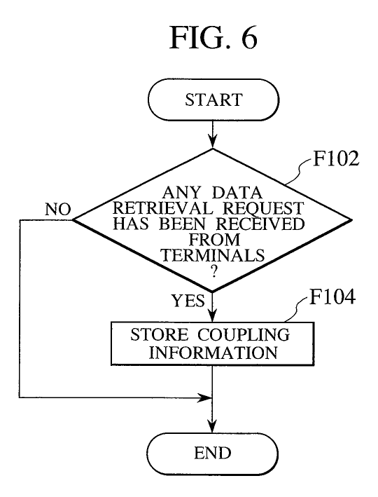

FIG. 6 is a flowchart for the relay apparatus 102 to put on hold data retrieval requests received from the terminals (101-1 and 101-N). This flowchart corresponds to Step Block S330 of FIG. 5.

The data retrieval request receiving unit 210 repeats Step Block S330 (FIG. 5) at particular intervals. The data retrieval request receiving unit 210 judges if it has received a data retrieval request from the terminals or not. If so (yes to F102), it maintains the connection to the data-retrieval requesting terminal without returning a response to the data retrieval request. The coupling information managing unit 220 then stores the terminal information D02 and the retrieval server information D04 of the data retrieval request as an entry to the coupling information D00 stored in the coupling information storage unit 222 (F104).

The data retrieval request receiving unit 210 repeats the process flow of FIG. 6, continuing to receive data retrieval requests from the terminals. Protocols through which to send the data retrieval requests to the data retrieval request receiving unit 210 can be different from terminal to terminal.

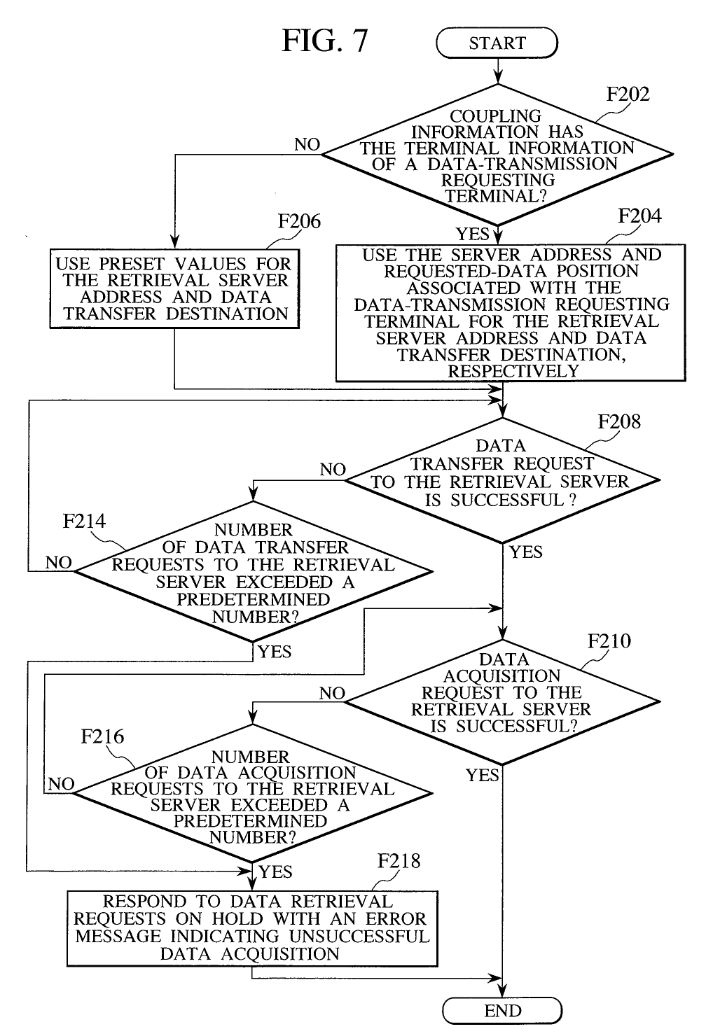

FIG. 7 corresponds to Step Block S332 of FIG. 5; it is a flowchart for the data retrieval request unit 214 to make requests to the retrieval server 104 for transfer of chat message data inside the retrieval server 104 to a particular position inside the retrieval server 104 and acquisition of the data from the retrieval server 104. after the data transmission request relay unit 212 relays a data transmission request from any of the terminals to the transmission server 103 (that is, after Step S306 of FIG. 5 is performed).

The data retrieval request unit 214 judges if the terminal address of the data-transmission requesting terminal has been registered in the terminal information D02 (F202). If so (yes to F202), the data retrieval request unit 214 acquires from its associated retrieval server information D04 the server address D10 and the requested-data position D12 of the retrieval server 104 (F204). By transferring the chat message data to the requested-data position D12, the retrieval server 104 can sort and store posted massages for each chat room. If the terminal address of the data-transmission requesting terminal has been not registered in the terminal information D02 (no to F202), e.g., when the data-transmission requesting terminal has not made a data retrieval request, predetermined values are used for the server address D10 and the requested-data position D12 of the retrieval server 104 (F206).

The relay apparatus 102 then requests the retrieval server 104 to transfer the data relayed to the transmission server 104 to the determined data transfer destination (F208). If that request fails (no to F208), e.g., when the retrieval server 104 has yet to receive the data due to network congestion or the like, the request is repeatedly made a particular number of times (F214). If the request is successful (yes to F208), the relay apparatus 102 makes a request to the retrieval server 104 for acquisition of the data and thereby acquires it (F210). Similar to the above data transfer request, if the data acquisition request fails (no to F210), that request is also made repeatedly a particular number of times (F216). If the data transfer request and the data acquisition request each fail the particular number of times (yes to F214 and F216), the response data generation unit 216 creates a response message to the effect that the data acquisition has failed and responds to the data retrieval requests on hold with that response message.

If the terminal address of the data-transmission requesting terminal has been not registered in the terminal information D02, an error message may instead be sent to the data-transmission requesting terminal in the above Step F206 without the relay apparatus 102 relaying its data transmission request (chat message).

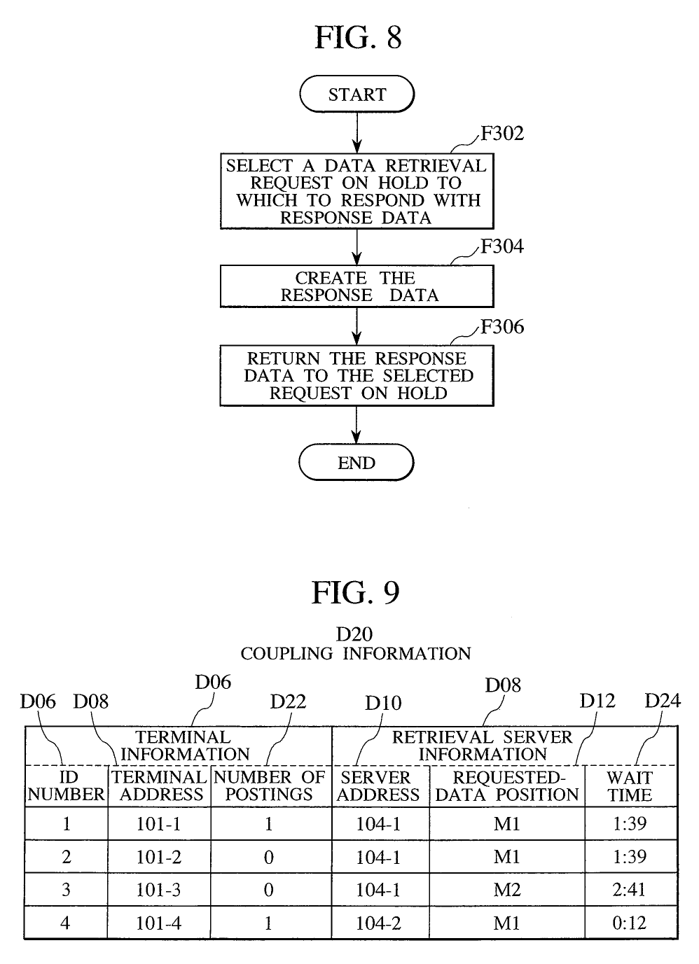

FIG. 8 corresponds to Step Block S334 of FIG. 5; it is a flowchart for the response data generation unit 216 to return response data to some of the data-retrieval requests on hold after the retrieval server 104 receives the response data (S320). The relay apparatus 102 selects, as terminals to which to respond, terminals with data retrieval requests on hold that have the same retrieval server information D04 in the coupling information D00 as that of the data-transmission requesting terminal (F302).

Assume, for example, that the relay apparatus 102 has relayed a data transmission request from the terminal 101-1 to the transmission server 103, and the terminal 101-1 has such coupling information D00 as shown in FIG. 4. In that case, the retrieval server information D04 of the record with the terminal address D08 “101-1” is selected as a record selection key. Then, records with the same retrieval server information D04 (104-1 and M1) as the key are selected; that is, the terminals with the ID number D06 “1” and “2” are selected.

Next, response data is created for the selected terminals based on the data received from the retrieval server 104 (F304). At this time, the response data generation unit 216 can create different response data for each of the selected terminals. For example, the response data generation unit 216 can create different response data based on each protocol D14 in the coupling information D00. The relay apparatus 102 then responds to the selected data retrieval requests on hold with the created response data (F306). Thereafter, the response data generation unit 216 deletes the entries of the data retrieval requests to which it has responded from the coupling information D00.

In accordance with the above-described Embodiment 1, data equivalent to chat messages can be distributed to multiple terminals after any of the terminals makes a data transmission request equivalent to a chat message. Further, a relay apparatus can be provided that implements a highly real-time, e-mail-based chat system which is available even from a terminal without the push architecture, can be used with an existing server, and is less prone to incongruity of posted messages.

### Embodiment 2

In Embodiment 2, the data retrieval request unit 214 does not necessarily make a request to the retrieval server 104 for data retrieval immediately after the data transmission request relay unit 212 relays a data transmission request from a terminal to the transmission server 103. Instead, the data retrieval request unit 214 makes the data retrieval request to the retrieval server 104 when the number of postings by a particular terminal exceeded a particular number and/or when a particular number of terminals posted chat messages, or when a particular amount of time has passed since the relaying of the data transmission request.

FIG. 9 is an example of the coupling information, designated D20 in Embodiment 2, which is stored by the coupling information storage unit 222. In addition to the coupling information D00 in Embodiment 1, the coupling information D20 further includes the number of postings D22 and a wait time D24. The number of postings D22 represents the number of times chat messages have been transmitted by a terminal since the terminal received the last response data. The wait time D24 represents the time during which the data retrieval request unit 214 has been withholding a data acquisition request to the retrieval server 104 since the data transmission request relay unit 212 relayed a data transmission request to the transmission server 103. The wait time D24 is updated at predetermined intervals by the coupling information managing unit 220 with the use of a timer.

The configuration of the relay apparatus of Embodiment 2 is the same as that of the relay apparatus 102-A of FIG. 2. As mentioned earlier, the relay apparatus of Embodiment 2 utilizes the request control unit 224 to control data retrieval requests to the retrieval server 104, which is not used in Embodiment 1. The request control unit 224 puts the data retrieval requests to the retrieval server 104 on hold on an as-needed basis with reference to the coupling information D20 after the data transmission request relay unit 212 relays a data transmission request to the retrieval server 103.

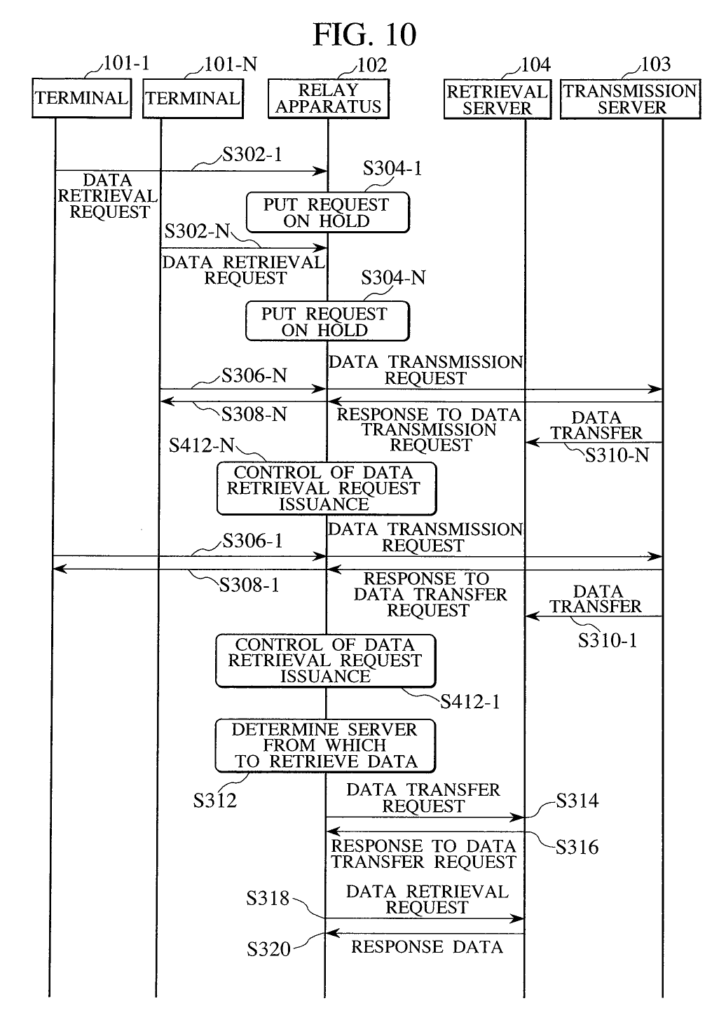

FIG. 10 is an example of the communication sequence of Embodiment 2. The part of the communication sequence up to the relay apparatus 102 relaying a data transmission request from any of the terminals 101-N to the transmission server 103, that is, from S302-1 up to S310-N, is the same as its counterpart of the communication sequence of Embodiment 1 (FIG. 5).

The request control unit 224 judges by the method described later whether the data retrieval request unit 214 should make a data retrieval request to the retrieval server 104 (S412-N) after the data transmission request relay unit 212 relays the data transmission request to the transmission server 103. Assume here that the data retrieval request is not made in Step S412-N.

Thereafter, the data transmission request relay unit 212 receives a data transmission request from the terminal 101-1, relays the request to the transmission server 104 (S306-1), and returns a response to the terminal 101-1 (S308-1). The transmission server 103 then transfers the received data (chat message data) to the retrieval server 104 (S310-1). After the transfer of the data, the request control unit 224 judges again by the method described later whether the data retrieval request unit 214 should make a data retrieval request to the retrieval server 104 (S412-1). Assume this time that the data retrieval request is made in Step S412-1. Then, the relay apparatus 102 starts the steps of retrieving the requested data from the retrieval server 104 (S312 through S320). These steps are the same as in the communication sequence of Embodiment 1.

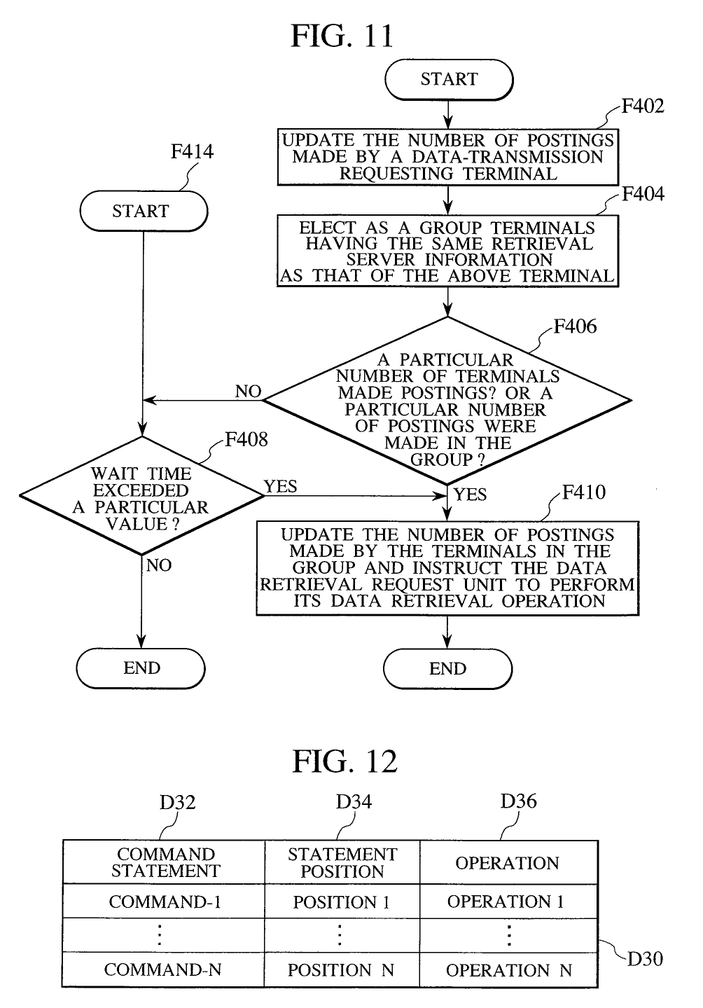

FIG. 11 is a flowchart for the request control unit 224 to judge whether the data retrieval request unit 214 should make requests to the retrieval server 104 for data transfer and acquisition. This flowchart corresponds to Steps S 412-N and S412-1 of FIG. 10. The process of the flowchart starts after the data transmission request relay unit 212 relays a data transmission request from a terminal to the transmission server 103 (S306-N).

First, the number of postings D22 of the data-transmission requesting terminal in the coupling information D20 is increased by one (F402). Next, the entries with the same retrieval server information D04 as that of the data-transmission requesting terminal are selected as a group in the coupling information D20 (F404). The request control unit 224 then judges whether the number of postings by a particular terminal in the group exceeded a predetermined number or whether the total number of postings by all the terminals in the group exceeded a predetermined number (F406). If either is true (yes to F406), all the numbers of postings D22 of the entries in the group are set to zero (F410). Thereafter, the data retrieval request unit 214 performs the steps of retrieving the requested data from the retrieval server 104 (S312 through S320 in FIG. 10). These steps are the same as the ones shown in FIG. 7.

If either of the predetermined numbers was not exceeded (no to F406), the request control unit 224 refers to the wait time D24 correlated with the terminal information D02 of the data-transmission requesting terminal in the coupling information D20. If the wait time D24 exceeded a particular amount of time (yes to F408), Step F410 and its subsequent steps are performed; if not (no to F408), the process ends. Step F414 starts again to perform another judgment on the wait time D24 (F408) after a particular amount of time unless another data transmission request is relayed.

In accordance with the above-described Embodiment 2, the relay apparatus 102 can collectively transmit to terminals chat messages posted during a particular amount of time or chat messages posted by all the chat participants, which means the terminals can also receive chat message data of a certain amount collectively. Thus, the relay apparatus of Embodiment 2 also has the effect of reducing the data traffic among the terminals and servers in addition to the effects of Embodiment 1.

### Embodiment 3

In Embodiment 3, a data retrieval or transmission request from a terminal includes a command statement specifying a particular operation to be performed by the relay apparatus 102. The relay apparatus 102 interprets the statement and performs the operation.

The configuration of the relay apparatus 102 of Embodiment 3 is the same as that of the relay apparatus 102-A of FIG. 2. As stated earlier, the relay apparatus of Embodiment 3 has the command statement interpretation/response generation unit 226 for interpreting a command statement included at a particular position of a request from a terminal and generating a response, which is not used in Embodiment 1.

FIG. 12 is an example of the control information D30 stored by the relay apparatus 102. The control information D30 is a table in which a command statement D32, a statement position D34, and an operation D36 are correlated with each other. The command statement D32 is to be interpreted by the command statement interpretation/response generation unit 226. The statement position D34 indicates a position in a request at which the command statement is located. The operation D36 is to be performed by the relay apparatus 102 when it receives the command statement.

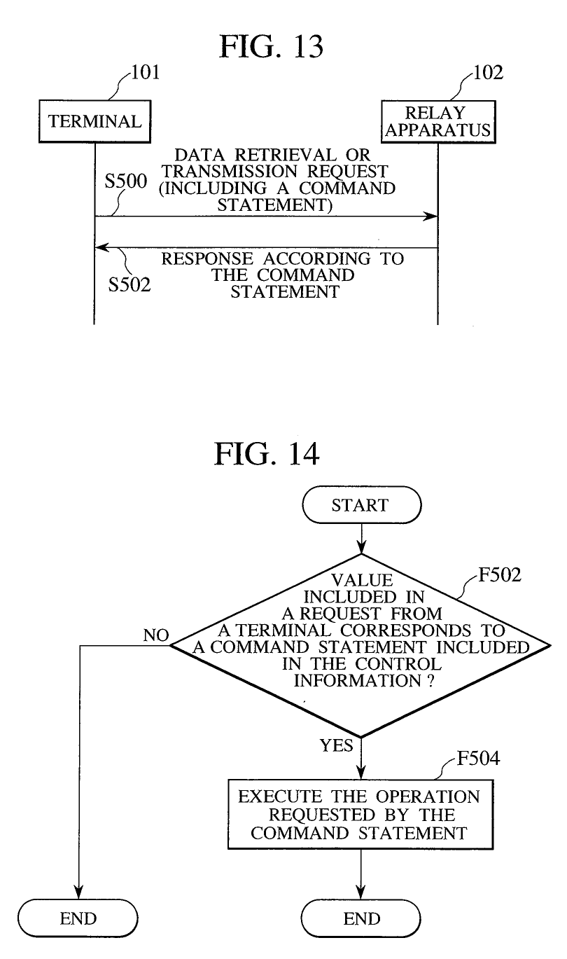

FIG. 13 is an example of the communication sequence of Embodiment 3. The relay apparatus 102 receives a data transmission or retrieval request including a command statement D32 from a terminal 101 (S500) and returns a response according to the command statement D32 (S502).

FIG. 14 is a flowchart for the relay apparatus 102 to perform a particular operation according to the command statement D32 included in a request from a terminal. The process of the flowchart begins after the relay apparatus 102 receives a data transmission or retrieval request from a terminal. The command statement interpretation/response generation unit 226 judges whether a particular position of the received request is provided with a command statement D32 listed in the control information D30. That particular position is specified by the statement position D34. The statement position D34 is analogous to the value of the subject header of an e-mail.

If the request does not include the command statement D32 (no to F502), the command statement interpretation/response generation unit 226 ends the process. If it does (yes to F502), the command statement interpretation/response generation unit 226 performs a particular operation associated with the command statement as specified by the control information D30.

Described next are examples of the operation (F504) performed by the command statement interpretation/response generation unit 226 according to a command statement.

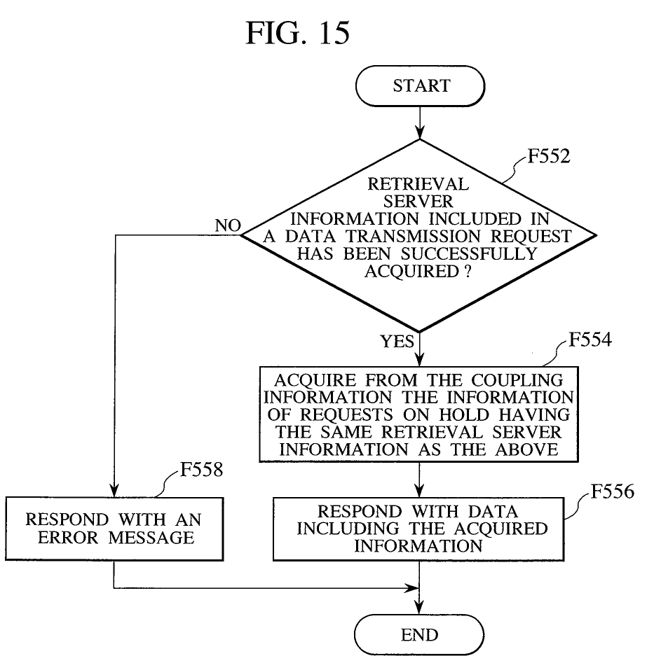

FIG. 15 is a flowchart for the command statement interpretation/response generation unit 226 to check to see how many data retrieval requests are on hold for a particular data position (a chat room) in the retrieval server 104, i.e., count the number of chat participants in the chat room, and then transmit the result to a terminal. The flowchart of FIG. 15 corresponds to Step F504 of FIG. 14.

First, the command statement interpretation/response generation unit 226 acquires the retrieval server information D04 included at a particular position of a request from a terminal (F552). If the acquisition of the retrieval server information D04 fails (no to F552), the command statement interpretation/response generation unit 226 creates response data including an error message and responds to the terminal with the response data (F558). If the acquisition of the retrieval server information D04 is successful (yes to F552), the command statement interpretation/response generation unit 226 acquires from the coupling information D00 the number of terminals having the same retrieval server information D04 as the acquired information (F554). The command statement interpretation/response generation unit 226 then creates response data including the number of terminals thus acquired and responds to the terminal with the response data (F556).

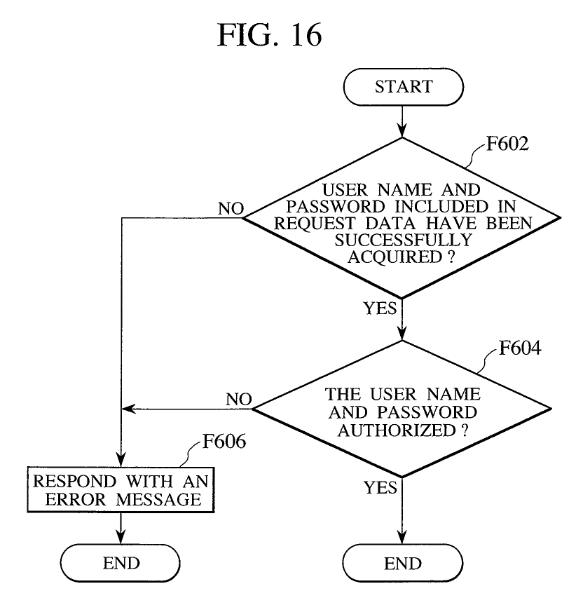

FIG. 16 is a flowchart for controlling a data retrieval request to the retrieval server 104 with the use of the user name and password included in the data retrieval request. The flowchart of FIG. 16 also corresponds to Step F504 of FIG. 14.

The command statement interpretation/response generation unit 226 first acquires the user name and password from a particular position in the data retrieval request (yes to F602). The command statement interpretation/response generation unit 226 then judges whether or not the acquired user name and password are authorized ones (F604) based on the combinations of authorized user names and passwords that are stored by the command statement interpretation/response generation unit 226. If the acquisition of the user name and password fails due to the absence of them (no to F602), or if they are not authorized ones (no to F604), the command statement interpretation/response generation unit 226 creates an error message to the effect that the request authorization has failed and sends the error message to the data-retrieval requesting terminal through the data retrieval request receiving unit 210 (F606), thus rejecting the data retrieval request.

If the user name and password are authorized ones (yes to F604), the data-retrieval request is accepted and put on hold as in Embodiment 1.

In accordance with the above-described Embodiment 3, the relay apparatus 102 can execute a particular operation by interpreting the command statement included in a request from a terminal. Thus, in addition to the effects of Embodiment 1, the relay apparatus 120 of Embodiment 3 also has the capability to notify chat room participants of the number of participants and to require authorization upon a user entering a particular chat room.

### Embodiment 4

In Embodiment 4, multiple relay apparatuses 102 are provided to diffuse a data processing load among them, as shown in FIG. 1.

The relay apparatuses 102 are connected with one another via the networks 105 or dedicated communication lines.

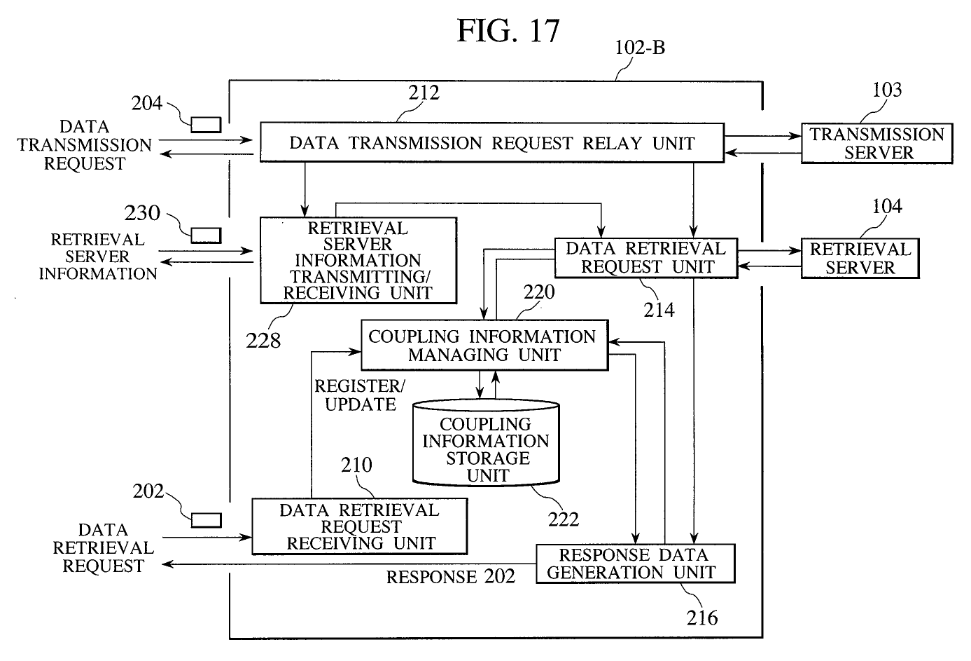

FIG. 17 illustrates the configuration of one of the relay apparatuses used in Embodiment 4 (the one of the relay apparatus is designated 102-B in FIG. 17). The relay apparatus 102-B includes, as shown in FIG. 17, a retrieval server information transmitting/receiving unit 228 for transmitting and receiving retrieval server information 230. Except for the retrieval server information transmitting/receiving unit 228, the relay apparatus 102-B is structurally the same as the relay apparatus 102-A of FIG. 2 used in Embodiment 1.

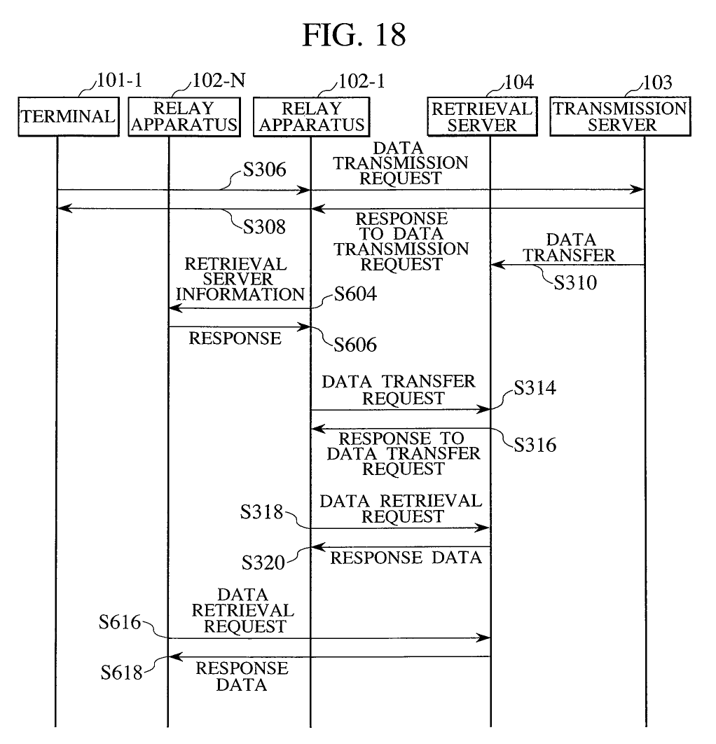

FIG. 18 is an example of the communication sequence of Embodiment 4.

The data transmission request relay unit 212 of a relay apparatus 102-1 relays a data transmission request, i.e., chat message data from a terminal 101-1 to the transmission server 103 (S306) and relays a response to the request to the terminal 101-1 (S308). The transmission server 103 then transfers the received data to the retrieval server 104 (S310). Right after the relaying of the data transmission request by the data transmission request relay unit 212 (S306), the retrieval server information transmitting/receiving unit 228 of the relay apparatus 102-1 transmits the retrieval server information 230 of the data-transmission requesting terminal (101-1) to part of or all of the data-exchangeable relay apparatuses (102-N) using a multicast scheme (S604).

The retrieval server information transmitting/receiving units 228 of the relay apparatuses 102-N that have received the retrieval server information 230 each return a response indicating the receipt of the retrieval server information 230 to the relay apparatus 102-1 (S606). It is to be noted that the retrieval server information 230 can be transmitted and received via a router or similar devices.

The data retrieval request unit 214 of the relay apparatus 102-1 then issues a data transfer request to the retrieval server 104 (S314) and receives a response from the same server 104 (S316). Thereafter, the data retrieval request unit 214 of the relay apparatus 102-1 issues a data retrieval request to the retrieval server 104 (S318) and receives a response from the same server 104 (S320).

After the receipt of the retrieval server information 230, each of the data retrieval request units 214 of the relay apparatuses 102-N also issues a data retrieval request to the retrieval server 104 (S616) and receives a response from the same server 104 (S618). Thereafter, the response data generation units 216 of the relay apparatuses 102-1 and 102-N each responds to data retrieval requests on hold according to Step S322 and its subsequent steps in the communication sequence of Embodiment 1.

In accordance with the above-described Embodiment 4, multiple relay apparatuses 102 are provided on the communication lines between terminals and servers, whereby the operation of distributing data to the multiple terminals after one of the relay apparatuses 102 relaying a data transmission request is shared among the multiple relay apparatuses 102. Thus, in addition to the effects of Embodiment 1, the relay apparatuses 120 of Embodiment 4 also have the capability to diffuse the data processing load among them and thus to respond to requests from a large number of terminals.

Further, the relay apparatuses of Embodiments 1 to 4 can be combined as desired, whereby a relay apparatus having combined effects can be provided.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A relay apparatus connected via a network to a plurality of terminals and a server, the relay apparatus comprising:
a data retrieval request receiving unit for receiving from one or more of the terminals data retrieval requests directed to the server and putting transmission of the requests on hold;
a data transmission request relay unit for relaying a data transmission request from any of the terminals to the server;
a data retrieval request unit for making a request to the server for data retrieval based on the data retrieval requests on hold and receiving the requested data from the server after the data transmission request relay unit relays the data transmission request from any of the terminals to the server; and
a response data generation unit for generating response data for the data retrieval requests on hold based on the requested data received by the data retrieval request unit from the server and transmitting the response data to the one or more of the terminals.

2. The relay apparatus defined in claim 1,
wherein for each of the data retrieval requests on hold, the data retrieval request receiving unit manages as coupling information the address of a data-retrieval requesting terminal and the server information that identifies the address of and a position inside the server from which to retrieve the requested data.

3. The relay apparatus defined in claim 2,
wherein by referring to the coupling information, the data retrieval request receiving unit transmits a data retrieval request based on the data retrieval requests on hold to a particular position inside the server with the use of the server information of the entries in the coupling information that have the same terminal address as that of a data-transmission requesting terminal.

4. The relay apparatus defined in claim 3,
wherein by referring to the coupling information, the response data generation unit generates, from the data received from the particular position inside the server in response to the data retrieval request transmitted by the data retrieval request receiving unit, response data directed to the data-retrieval requesting terminals having the same server information as that of the data-transmission requesting terminal in the coupling information.

5. The relay apparatus defined in claim 1,
wherein the data retrieval request receiving unit manages, as coupling information, protocols used by the terminals having data retrieval requests put on hold, and
wherein the response data generation unit generates the response data according to the protocols.

6. The relay apparatus defined in claim 1, further including a request control unit for controlling data transmission/retrieval requests such that the data retrieval request receiving unit continues to put data retrieval requests on hold until a predetermined number of data transmission requests from the terminals are relayed from any of the terminals to the server and such that the data retrieval request unit makes a data retrieval request based on the data retrieval requests on hold after the predetermined number is exceeded,
wherein according to an instruction from the request control unit, the data retrieval request unit transmits the data retrieval request based on the data retrieval requests on hold.

7. The relay apparatus defined in claim 1, further including a request control unit for controlling data transmission/retrieval requests such that the data retrieval request receiving unit continues to put data retrieval requests on hold until data transmission requests from a predetermined number of terminals are relayed from a predetermined number of terminals to the server and such that the data retrieval request unit makes a data retrieval request based on the data retrieval requests on hold after the predetermined number is exceeded,
wherein according to an instruction from the request control unit, the data retrieval request unit transmits the data retrieval request based on the data retrieval requests on hold.

8. The relay apparatus defined in claim 1, further including a request control unit for controlling data transmission/retrieval requests such that the data retrieval request receiving unit continues to put data retrieval requests on hold until a predetermined amount of time passes and such that the data retrieval request unit makes a data retrieval request based on the data retrieval requests on hold after the passage of the predetermined amount of time,
wherein according to an instruction from the request control unit, the data retrieval request unit transmits the data retrieval request based on the data retrieval requests on hold.

9. The relay apparatus defined in claim 1, further including a command statement interpretation/response generation unit for interpreting the command statement included in a data retrieval request received from any of the terminals and performing a particular operation according to the command statement.

10. The relay apparatus defined in claim 9,
wherein according to the command statement, the command statement interpretation/response generation unit transmits, to the terminal that has transmitted the data retrieval request having the command statement, the information on the data retrieval requests on hold that have the same server information as that of the data retrieval request having the command statement.

11. The relay apparatus defined in claim 9,
wherein according to the command statement, the command statement interpretation/response generation unit executes an authorization operation on the data retrieval request, and if the data retrieval request fails to be authorized, the command statement interpretation/response generation unit rejects the data retrieval request.

12. The relay apparatus defined in claim 1, further including a server information transmitting/receiving unit for exchanging the server information of a data retrieval request with other relay apparatuses after the data transmission request relay unit relays the data transmission request to the server,
wherein after the data transmission request relay unit relays the data transmission request to the server, the server information transmitting/receiving unit acts as an event trigger to instruct the data retrieval request units of the other relay apparatuses to each make a data retrieval request based on the data retrieval requests put on hold by the other relay apparatuses.
